(19) United States
(12) Patent Application Publication
(10) Pub. No.: US 2026/0015542 A1
(43) Pub. Date: Jan. 15, 2026

(54) PHOTORESPONSIVE COMPOSITION

(71) Applicant: CANON KABUSHIKI KAISHA, Tokyo (JP)

(72) Inventors: YUTAKA YOSHIMASA, Kanagawa (JP); YOSHIHIRO OHASHI, Tokyo (JP)

(21) Appl. No.: 19/337,635

(22) Filed: Sep. 23, 2025

Related U.S. Application Data
(63) Continuation of application No. PCT/JP2024/009260, filed on Mar. 11, 2024.

(30) Foreign Application Priority Data
Mar. 28, 2023 (JP) 2023-052461

(51) Int. Cl. C09K 11/02; C08K 9/08; C09K 11/66

(52) U.S. Cl. CPC C09K 11/025; C08K 9/08; C09K 11/665; C08K 2201/011

(57) ABSTRACT

A photoresponsive composition includes a medium, a first particle including a first nanoparticle, a first protective layer, and a third protective layer and supported by the medium, the first nanoparticle having a photoresponsive perovskite-type crystalline structure, the first protective layer including a first organic group and a first linking portion coordinating to the first nanoparticle, the first protective layer protecting the first nanoparticle, the third protective layer being disposed between the medium and the first protective layer and protecting the first particle, and a second particle including a second nanoparticle and a second protective layer and supported by the medium, the second nanoparticle having a perovskite-type crystalline structure with a photoresponsivity different from that of the first nanoparticle, the second protective layer including a second organic group and a linking portion coordinating to the second nanoparticle, the second protective layer protecting the second nanoparticle.

### CROSS-REFERENCE TO RELATED APPLICATIONS

This application is a Continuation of International Patent Application No. PCT/JP2024/009260, filed Mar. 11, 2024, which claims the benefit of Japanese Patent Application No. 2023-052461, filed Mar. 28, 2023, both of which are hereby incorporated by reference herein in their entirety.

### BACKGROUND

### Field of the Technology

The present disclosure relates to a photoresponsive composition that responds to light irradiation.

### Description of the Related Art

Quantum dots with a perovskite-type crystalline structure have narrow full width at half maximum in spectral sensitivity characteristics and exhibit high color purity, and thus are known to be applied to organic electroluminescence (EL) materials and quantum dot light-emitting materials. Moreover, there is an advantage that materials responding to light in a wide wavelength range can be easily provided since the absorption and emission wavelengths can be controlled by the halogen composition.

Japanese Patent Laid-Open No. 2018-197782 describes quantum dots with a perovskite crystalline structure that absorb light from a light-emitting element and convert the light into at least one of red (R) light, green (G) light, and blue (B) light for emission, and a liquid crystal display apparatus including a light conversion layer that includes such quantum dots.

Japanese Patent Laid-Open No. 2021-6900 describes a liquid crystal display apparatus including, as its backlight, a light-emitting element and a wavelength conversion layer that includes perovskite-type quantum dots having different compositions for converting light from the light-emitting element into red light and green light, respectively. The liquid crystal display apparatus described in Japanese Patent Laid-Open No. 2021-6900 enhances the color purity of red and green in the light emitted from the backlight by including the wavelength conversion layer containing perovskite-type quantum dots in the backlight. Moreover, the liquid crystal display apparatus described in Japanese Patent Laid-Open No. 2021-6900 adjusts the intensity of spectrally separated display colors depending on the emission color of pixels by including a display device that includes liquid crystal elements for controlling the transmittance of light from the wavelength conversion layer or light-emitting element and an optical filter.

On the other hand, when perovskite-type quantum dots of different compositions are mixed within the same medium, there arises an issue that the perovskite-type quantum dots of different compositions exchange halogens to change each other's compositions, resulting in a change in photoresponsiveness (color mixing).

In Japanese Patent Laid-Open No. 2018-197782, color mixing is reduced by providing each of the perovskite quantum dots of different compositions with a protective layer having organic groups. Japanese Patent Laid-Open No. 2021-6900 does not include direct mention of color mixing, but color mixing is avoided by employing perovskite-type quantum dots as green light emitters and non-perovskite-type quantum dots that have low reactivity with perovskite-type quantum dots as red light emitters.

However, with the wavelength conversion layer described in Japanese Patent Laid-Open No. 2018-197782, there have been cases where the composition changes over time, resulting in color mixing. The wavelength conversion layer described in Japanese Patent Laid-Open No. 2018-197782 has a protective layer provided for the respective quantum dots, but there are concerns that these layers may not provide sufficient protection in all cases. Moreover, with the wavelength conversion layer described in Japanese Patent Laid-Open No. 2021-6900, there has been an issue of limitations in wavelength selection characteristics such as light absorption and color purity since non-perovskite-type quantum dots are employed for red among the quantum dots corresponding to green and red.

### SUMMARY

The present disclosure has been achieved in view of the foregoing issues, and is directed to providing a photoresponsive composition that includes perovskite-type quantum dots supported by a common medium and having mutually different compositions and in which color mixing is reduced.

A photoresponsive composition includes a medium, a first particle including a first nanoparticle, a first protective layer, and a third protective layer and supported by the medium, the first nanoparticle having a photoresponsive perovskite-type crystalline structure, the first protective layer including a first organic group and a first linking portion coordinating to the first nanoparticle, the first protective layer being configured to protect the first nanoparticle, the third protective layer being disposed between the medium and the first protective layer and configured to protect the first particle, and a second particle including a second nanoparticle and a second protective layer and supported by the medium, the second nanoparticle having a perovskite-type crystalline structure with a composition different from that of the first nanoparticle, the second protective layer including a second organic group and a linking portion coordinating to the second nanoparticle, the second protective layer being configured to protect the second nanoparticle.

Features of the present disclosure will become apparent from the following description of embodiments with reference to the attached drawings.

### BRIEF DESCRIPTION OF THE DRAWINGS

FIG. 1 is a diagram illustrating a schematic structure of a photoresponsive composition according to a first embodiment.

FIG. 2A is a partial enlarged view illustrating a schematic configuration of a first particle according to the present embodiment. FIG. 2B is a partial enlarged view illustrating a schematic configuration of the first particle according to the present embodiment. FIG. 2C is a partial enlarged view illustrating a schematic configuration of a second particle according to the present embodiment. FIG. 2D is a partial enlarged view illustrating a schematic configuration of the second particle according to the present embodiment.

FIG. 3 is a diagram illustrating a schematic structure of a photoresponsive composition according to a second embodiment.

FIG. 4 is a diagram illustrating a schematic structure of a photoresponsive composition according to a third embodiment.

FIG. 5 is a diagram illustrating a schematic structure of a wavelength conversion layer including a photoresponsive composition according to a fourth embodiment.

### DESCRIPTION OF THE EMBODIMENTS

Desirable embodiments of the present disclosure will be described in detail below with reference to the drawings. Dimensions, materials, shapes, relative arrangement, and the like of components described in these embodiments are not intended to limit the scope of this disclosure.

### First Embodiment

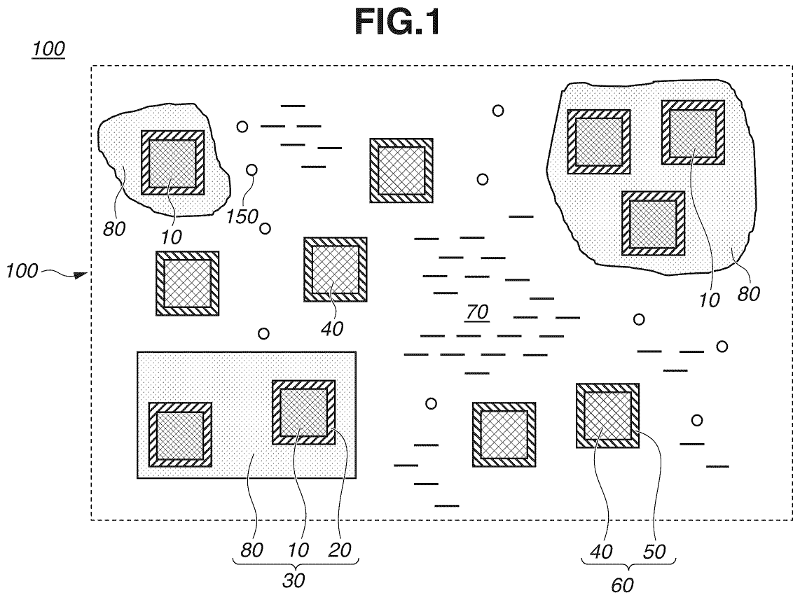

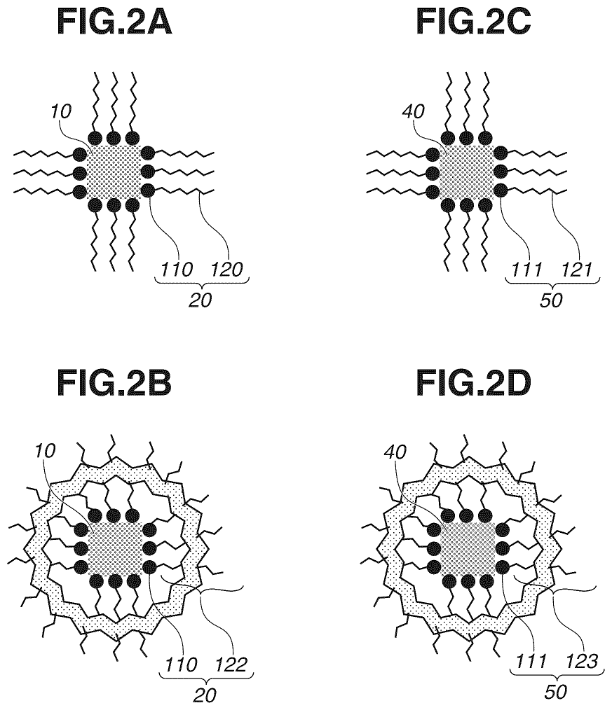

A photoresponsive composition according to a first embodiment will be described with reference to FIGS. 1 and 2A to 2D.

A photoresponsive composition 100 according to the first embodiment includes a medium 70. As illustrated in FIG. 1, the photoresponsive composition 100 also includes first particles 30 that each include a first nanoparticle or nanoparticles 10 having a photoresponsive perovskite-type crystalline structure and a first protective layer 20 protecting the first nanoparticles 10 and are supported by the medium 70. As illustrated in FIG. 2B, the first protective layer 20 is configured to protect the first nanoparticle 10 by including first organic groups 122 and first linking portions 110 that coordinate to the first nanoparticle 10.

The first particles 30 are configured to further include a third protective layer 80 that is disposed between the medium 70 and the first protective layer 20 and protects the first nano particles 10.

As illustrated in FIG. 1, the photoresponsive composition 100 also includes second particles 60 that each include a second nanoparticle 40 having a perovskite-type crystalline structure with a composition different from that of the first nanoparticles 10 and a second protective layer 50 protecting the second nanoparticle 40 and are supported by the medium 70. As illustrated in FIG. 2D, the second protective layer 50 is configured to include second organic groups 123 and linking portions 111 that coordinate to the second nanoparticle.

### (Nanoparticles)

For the first nanoparticles 10 and the second nanoparticles 40 according to the present embodiment, semiconductor nanocrystals having a perovskite-type crystalline structure including an A-site (monovalent cation), a B-site (divalent cation), and X-sites (monovalent anions including halide anions) as their constituents are employed. Perovskite-type crystalline structures are also referred to as perovskite-type structures, ABX₃-type crystalline structures, or ABX₃-type structures. Double perovskite-type crystalline structures expressed as A2B1B2X₆ are also included in perovskite-type crystalline structures. As employed in this description, at least either the first nanoparticles 10 or the second nanoparticles 40 may be referred to as luminescent nanoparticles, luminescent nanocrystals, photoresponsive nanocrystals, or quantum dots.

The nanoparticles desirably have an average particle diameter of 1 nm or more and 30 nm or less, more desirably 2 nm or more and 25 nm or less. Average particle diameters of less than 1 nm can result in insufficient stability. Average particle diameters of greater than 30 nm can result in insufficient dispersibility.

### [A-Site of Perovskite-Type Structure]

Monovalent cations are employed at the A-site. Examples of the monovalent cations employed at the A-site include nitrogen-containing organic compound cations such as ammonium cation (NH₄⁺) and alkylammonium cations with six or fewer carbon atoms, formamidinium cation (HC(NH₂)₂⁺), guanidinium cation (C(NH₂)₃⁺), imidazolium cation, pyridinium cation, and pyrrolidinium cation, and alkali metal cations such as lithium cation (Li⁺), sodium cation (Na⁺), potassium cation (K⁺), rubidium cation (Rb⁺), and cesium cation (Cs⁺).

Since these monovalent cations employed at the A-site have small ionic radii and are sized to fit within the crystal lattice, the perovskite compounds can form stable three-dimensional crystals.

Desirable examples of alkylammonium cations with six or fewer carbon atoms include methylammonium cation (CH₃NH₃⁺), ethylammonium cation (C₂H₅NH₃⁺), and propylammonium cation (C₃H₇NH₃⁺).

In view of high luminous efficiency, at least one of methylammonium cation, formamidinium cation, and cesium cation is desirably employed at the A-site. In view of suppressed color change, cesium cation is more desirably employed at the A-site. Two or more types of these monovalent cations may be employed at the A-site in combination.

If the A-site is a cesium cation, cesium salt can be cited as a raw material for synthesizing the luminescent nanocrystal first nanoparticles 10 and second nanoparticles 40 to be described below. Examples of the cesium salt that is appropriately employed include cesium chloride, cesium bromide, cesium iodide, cesium hydroxide, cesium carbonate, cesium hydrogen carbonate, cesium bicarbonate, cesium formate, cesium acetate, cesium propionate, cesium pivalate, and cesium oxalate. Among these candidate cesium salts, an appropriate one can be used depending on the synthesis method.

If the A-site is other alkali metal cations, salts and the like where the cesium element of the foregoing cesium compounds is replaced with other alkali metal cation elements can be used as raw materials.

If the A-site is a nitrogen-containing organic compound cation such as methylammonium cation, non-salt neutral compounds such as methylamine can be used as raw materials. Two or more of these raw materials may be used in combination.

### [B-Site of Perovskite-Type Crystalline Structure]

For the B-site of the perovskite-type crystalline structure, divalent cations including divalent transition metal cations and divalent typical metal cations are employed.

Divalent transition metal cations employed include scandium cation (Sc²⁺), titanium cation (Ti²⁺), vanadium cation (V²⁺), chromium cation (Cr²⁺), manganese cation (Mn²⁺), iron cation (Fe²⁺), cobalt cation (Co²⁺), nickel cation (Ni²⁺), copper cation (Cu²⁺), palladium cation (Pd²⁺), europium cation (Eu²⁺), and ytterbium cation (Yb²⁺).

Divalent typical metal cations that can be employed include magnesium cation (Mg²⁺), calcium cation (Ca²⁺), strontium cation (Sr²⁺), barium cation (Ba²⁺), zinc cation (Zn²⁺), cadmium cation (Cd²⁺), germanium cation (Ge²⁺), tin cation (Sn²⁺), and lead cation (Pb²⁺).

Of these divalent cations, divalent typical metal cations are desirable in terms of stable growth of three-dimensional crystal. Tin cation and lead cation are more desirable. Lead cation is particularly desirable in view of high luminous intensity. Two or more of these divalent cations may be used in combination, and the perovskite crystalline structure may be a so-called double perovskite type.

When the B-site is a lead cation, lead compounds can be cited as raw materials for synthesizing the first nanoparticles 10 and the second nanoparticles 40 to be described below. An appropriate one can be used depending on the synthesis method. Lead compounds employed include lead chloride, lead bromide, lead iodide, lead oxide, lead hydroxide, lead sulfide, lead carbonate, lead formate, lead acetate, lead 2-ethylhexanoate, lead oleate, lead stearate, lead naphthenate, lead citrate, lead maleate, and lead acetylacetonate. When the B-site is other divalent metal cations, salts and the like where the lead element of the foregoing lead compounds is replaced with other divalent metal cation elements can be used as raw materials. Two or more of these raw materials may be used in combination.

### [X-Sites of Perovskite-Type Crystalline Structure]

For X in the perovskite-type crystalline structure, monovalent anions including halide anions are employed. Halide anions include fluoride anion (F⁻), chloride anion (Cl⁻), bromide anion (Br⁻), and iodide anion (I⁻). Of these, chloride anion, bromide anion, or iodide anion is desirable from the viewpoint of forming stable three-dimensional crystal and exhibiting strong luminescence in the visible light region. The luminescent color is blue when chloride anion is used, green when bromide anion is used, and red when iodide anion is used.

Two or more types of halide anions may be used in combination. In particular, when chloride anion, bromide anion, and iodide anion are used in combination, the luminescence wavelength of the first nanoparticles 10 and second nanoparticles 40 can be set to desired wavelengths depending on the content ratio of the anion types. In other words, when chloride anion, bromide anion, and iodide anion are used in combination in particular, luminescence spectra covering almost the entire visible light region from blue to red can desirably be obtained while maintaining narrow full widths at half maximum depending on the content ratio of the anion types.

The X-sites may include monovalent anions other than halide anions. Examples of such monovalent anions include pseudohalide anions such as cyanide anion (CN⁻), thiocyanate anion (SCN⁻), and isothiocyanate anion (CNS⁻). As raw materials for synthesizing the first nanoparticles 10 and the second nanoparticles 40, appropriate ones can be selected from among salts having counter cations at the A- and B-sites, such as cesium chloride and lead bromide, salts formed with other cations, and the like depending on the synthesis method.

The first nanoparticles 10 and the second nanoparticles 40 according to the present embodiment can be manufactured by the following processes. For example, a hot injection method in which raw material solutions are mixed at high temperature and rapidly cooled after fine particle formation to obtain a stable product or a ligand-assisted reprecipitation method in which fine particles are obtained through reprecipitation utilizing the difference in miscibility of the product with solvents is employed.

Another manufacturing method employed is a room temperature synthesis method in which fine particles are obtained by mixing a mixture of A-site raw materials and B-site raw materials, which are non-halides free of X-site components, with a separately prepared X-site raw material solution under mild conditions at around room temperature. Other examples of the manufacturing methods employed include a mechanochemical method in which product fine particles are obtained through reaction of solid raw materials caused by mechanical mixing such as milling or ultrasonic treatment, and an in-situ synthesis method in which raw material solutions are applied to a substrate, followed by direct crystal growth to obtain reaction products.

It is desirable that the first particles 30 to be described below contain a greater proportion of either bromine or iodine, and the second particles 60 contain a greater proportion of the other of bromine and iodine.

### (First Particles)

In the present embodiment, as illustrated in FIG. 1, the first particles 30 each include first nanoparticles 10 that have a perovskite-type crystalline structure and the first protective layer 20 that includes first organic groups 122 and first linking portions 110 coordinating to the first nanoparticles 10 and protects the first nanoparticles 10. The first particles 30 may be separated from one another. A plurality of first particles 30 may be connected via the first protective layer 20 to form secondary particles.

### (Second Particles)

The second particles 60 each include a second nanoparticle 40 that has a perovskite-type crystalline structure and the second protective layer 50 that includes second organic groups 123 and second linking portions 111 coordinating to the second nanoparticle and protects the second nanoparticle 40. The second particles 60 may be separated from one another. A plurality of second particles 60 may be connected via the second protective layer 50 to form secondary particles.

It is desirable that the first particles 30 exhibit luminance characteristics of emitting a greater amount of either green light or red light, and the second particles 60 luminance characteristics of emitting a greater amount of the other of green light and red light.

### (First Protective Layer, Second Protective Layer)

The first nanoparticles 10 are each protected by the first protective layer 20 including organic groups 120 and 122 and linking portions 110. The second nanoparticles 40 are each protected by the second protective layer 50 including organic groups 121 and 123 and linking portions 111. The protective functions are presumed to be developed due to the following two reasons. The first presumption is that hydrophilic linking portions coordinate to the nanocrystals and form complete or partial bonds with halogens, which are also hydrophilic, and the halogens become less likely to detach from the nanocrystals.

The second presumption is that the organic groups form a hydrophobic field, which makes hydrophilic halogens less likely to detach from the nanocrystals. The protective layers may be made of low molecular weight compounds or made of polymer compounds. The protective layers may contain both low molecular weight compounds and polymer compounds. In view of more effective prevention of color mixing, the protective layers are desirably made mainly of polymer compounds.

For the polymer compounds, copolymers (to be described below) obtained by polymerizing at least two types of monomers each containing linking portions and organic groups listed below can be used.

### (First Linking Portions, Second Linking Portions)

Examples of the first linking portions 110 and the second linking portions 111 include cationic groups, anionic groups, zwitterionic groups, and salts thereof. Examples of anionic groups include carboxy groups, sulfo groups, and phosphoryl groups. Examples of cationic groups include amino groups and quaternary ammonium cations. Examples of zwitterionic groups include carboxybetaine groups, phosphorylcholine groups, and sulfobetaine groups.

The same linking portions may be employed, or different linking portions may be employed, for the first linking portions 110 and the second linking portions 111.

### (First Organic Groups, Second Organic Groups)

For the first organic groups 120 and 122 and the second organic groups 121 and 123, a linear, branched or cyclic alkyl group, a linear, branched or cyclic heteroalkyl group, an aryl group, a heteroaryl group, an aralkyl group, or a heteroaralkyl group is employed. The first organic groups 120 and 122 and the second organic groups 121 and 123 may each include substituents as a part of the organic groups.

For the first organic groups 120 and 122 and the second organic groups 121 and 123, the same organic groups may be employed, or different organic groups may be employed.

### (Content of First and Second Protective Layers)

The content of the first protective layer 20 relative to the first nanoparticles 10 is desirably 1 part by mass to 1000 parts by mass, desirably 5 parts by mass to 500 parts by mass, more desirably 10 parts by mass to 300 parts by mass, with the content of the first nanoparticle 10 as 100 parts by mass. Below 1 part by mass, the effect of the protective layer may not be sufficiently exerted, and color mixing may fail to be prevented. Above 1000 parts by mass, the solubility and dispersibility of the first protective layer 20 to the medium 70 may drop, and color mixing may fail to be prevented. The content of the first protective layer 20 relative to the first nanoparticles 10 can be adjusted as appropriate depending on the types and applications of the first nanoparticles 10 and the first protective layer 20.

The content of the second protective layer 50 relative to the second nanoparticles 40 is desirably 1 part by mass to 1000 parts by mass, desirably 5 parts by mass to 500 parts by mass, more desirably 10 parts by mass to 300 parts by mass, with the content of the second nanoparticles 40 as 100 parts by mass. Below 1 part by mass, the effect of the second protective layer 50 may not be sufficiently exerted, and color mixing may fail to be prevented. Above 1000 parts by mass, the solubility and dispersibility of the second protective layer 50 to the medium 70 may drop, and color mixing may fail to be prevented. The content of the second protective layer 50 relative to the second nanoparticles 40 can be adjusted as appropriate depending on the types and applications of the second nanoparticles 40 and the second protective layer 50.

Examples of a method for coordinating the first protective layer 20 to the surface of the first nanoparticles 10 include a method of applying the first protective layer 20 after synthesis of the first nanoparticles 10, and a method of synthesizing the first nanoparticles 10 where the first nanoparticles 10 and the first protective layer 20 coexist. Similarly, examples of a method for coordinating the second protective layer 50 to the surface of the second nanoparticles 40 include a method of applying the second protective layer 50 after synthesis of the second nanoparticles 40, and a method of synthesizing the second nanoparticle 40 where the second nanoparticles 40 and the second protective layer 50 coexist.

### (Method for Manufacturing Polymer Compounds)

A method for manufacturing polymer compounds that can be used for the first protective layer 20 and the second protective layer 50 will now be described in detail. The method for manufacturing polymer compounds is not limited in particular, as long as polymer compounds having the foregoing structure can be obtained. For example, the polymer compounds can be manufactured by the following method (i) or (ii).

An example of a method (i) for manufacturing a polymer compound includes manufacturing monomer having a structural unit containing a linking portion or organic group and then polymerizing the monomer to manufacture the polymer compound. An example of a method (ii) for manufacturing a polymer compound includes synthesizing a polymer main chain and then bonding linking portions or organic groups to the polymer main chain.

In view of the availability of monomers and control of functional group content, the method (i) is desirably used for manufacture. A method for synthesizing a polymer compound containing zwitterionic groups as linking portions using the method (i) will be described in detail.

As monomers for introducing linking portions into the polymer compound, vinyl ether derivatives, acrylate derivatives, methacrylate derivatives, α-olefin derivatives, aromatic vinyl derivatives, and the like can be used. In view of the ease of monomer manufacture, acrylate derivatives or methacrylate derivatives are desirably used as the monomers.

The applicable acrylate derivatives or methacrylate derivatives can be manufactured by methods such as that described in the following literature: K. Ishihara, et al., “Polymer Journal”, (Japan), The Society of Polymer Science, 1990, Vol. 22, p. 355-360.

Examples of the monomer polymerization methods include radical polymerization and ionic polymerization. Living polymerization aimed at controlling molecular weight distribution and structure can also be used. Industrially, radical polymerization is desirably used.

Radical polymerization can be performed by using radical polymerization initiators, irradiation with light such as radiation and laser light, combination of photopolymerization initiators with light irradiation, heating, or the like. Any radical polymerization initiator that can generate radicals and initiate polymerization reactions may be used as the foregoing radical polymerization initiator, being selected from compounds that generate radicals through the action of heat, light, radiation, redox reactions, and the like.

Examples include azo compounds, organic peroxides, inorganic peroxides, organometallic compounds, and photopolymerization initiators.

More specifically, examples include azo compounds such as 2,2′-azobisisobutyronitrile (AIBN) and 2,2′-azobis(2,4-dimethylvaleronitrile), organic peroxides such as benzoyl peroxide (BPO), tert-butyl peroxypivalate, and tert-butyl peroxyisopropyl carbonate, inorganic peroxides such as potassium persulfate and ammonium persulfate, and redox initiators such as hydrogen peroxide-iron (II) salt systems, BPO-dimethylaniline systems, and cerium (IV) salt-alcohol systems. Examples of photopolymerization initiators include acetophenone-based, benzoin ether-based, and ketal-based initiators. Two or more of these radical polymerization initiators may be used in combination.

The desirable temperature range of the polymerization temperature for the foregoing vinyl monomers varies depending on the type of polymerization initiator used and is not limited in particular. The polymerization is typically performed at temperatures of −30° C. to 150° C. A more desirable temperature range is 40° C. to 120° C.

The amount of polymerization initiator used here is 0.1 parts by mass or more and 20 parts by mass or less with respect to 100 parts by mass of the foregoing monomer. The amount used is desirably adjusted to obtain a polymer compound with the target molecular weight distribution.

As for the polymerization method, any method such as solution polymerization, suspension polymerization, emulsion polymerization, dispersion polymerization, precipitation polymerization, and bulk polymerization can be used, and there is no particular limitation.

The obtained polymer compound can be subjected to purification treatment as needed. The purification method is not limited in particular, and methods such as reprecipitation, dialysis, and column chromatography can be used.

The structure of the manufactured polymer compound can be identified using various instrumental analyses. Analytical instruments that can be used include nuclear magnetic resonance (NMR), gel permeation chromatography (GPC), and inductively coupled plasma atomic emission spectroscopy (ICP-AES).

### (Medium)

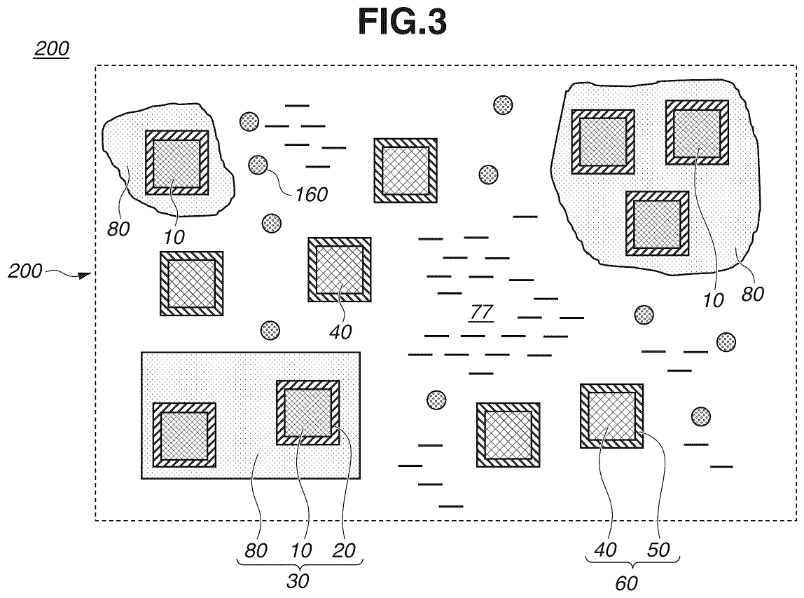

As illustrated in FIGS. 1 and 3, the medium 70 and a medium 77 are selected from liquid (medium 70) and solid (medium 77), respectively. For the liquid, a solvent or a polymerizable compound can be used. In other words, the medium 70 can contain a polymerizable compound 150 or a solvent. For the solid, a polymer matrix can be used. The medium 77 may contain a polymer matrix where both the first particles 30 and the second particles 60 are dispersed. A polymer obtained by crosslinking and polymerizing a polymerizable compound can be employed as the polymer matrix. A polymer matrix of sheet form with a sheet thickness taking into consideration the purpose of ensuring optical coupling surfaces for light reception and emission, the deactivation depth (penetration depth) of primary light, and the extraction efficiency of secondary light is employed. Examples of the solvent usable include alkanes such as pentane and hexane, cycloalkanes such as cyclopentane and cyclohexane, esters such as ethyl acetate, butyl acetate, and benzyl acetate, ethers such as diethyl ether and tetrahydrofuran, ketones such as cyclohexanone and acetone, and alcohols such as methanol, ethanol, isopropanol, butanol, and hexanol. Other examples include monoacetate compounds such as diethylene glycol monoethyl ether acetate, ethylene glycol monoethyl ether acetate, diethylene glycol monobutyl ether acetate, and dipropylene glycol methyl ether acetate, diacetate compounds such as 1,4-butanediol diacetate and propylene glycol diacetate, and triacetate compounds such as glyceryl triacetate. A boiling point of 300° C. or lower is adopted for the solvent because it facilitates removal of the solvent before curing of the polymerizable compound.

### (Polymerizable Compounds)

The polymerizable compound 150 promotes polymerization upon receiving light, heat, or other energy, and becomes a component that imparts viscosity to the photoresponsive composition to cure. Radical polymerizable compounds or cationic polymerizable compounds can be used as the polymerizable compound. These may be used alone or in combination of two or more. Both photopolymerizable compounds and thermally polymerizable compounds can be used. In this description, the polymerized form of the polymerizable compound 150 with increased viscosity may be referred to as a polymer 160.

Examples of usable radical polymerizable compounds include monofunctional (meth)acrylate compounds, difunctional (meth)acrylate compounds, trifunctional or higher (meth)acrylate compounds, hydroxyl group-containing (meth)acrylate compounds, carboxyl group-containing (meth)acrylate compounds, and vinyl compounds.

Examples of usable monofunctional (meth)acrylates include methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, cyclohexyl (meth)acrylate, dicyclopentenyl (meth)acrylate, dicyclopentenyloxyethyl (meth)acrylate, benzyl (meth)acrylate, 3,3,5-trimethylcyclohexyl acrylate, tetrahydrofurfuryl (meth)acrylate, phenoxyethyl (meth)acrylate, methoxyethyl (meth)acrylate, ethyl carbitol (meth)acrylate, isobornyl (meth)acrylate, methoxytriethylene glycol (meth)acrylate, (2-methyl-2-ethyl-1,3-dioxolan-4-yl)methyl (meth)acrylate, (3-ethyloxetan-3-yl)methyl (meth)acrylate, and cyclic trimethylolpropane formal (meth)acrylate.

Examples of usable difunctional (meth)acrylate compounds include 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, triethylene glycol di(meth)acrylate, tetraethylene glycol di(meth)acrylate, polyethylene glycol 200 di(meth)acrylate, polyethylene glycol 300 di(meth)acrylate, polyethylene glycol 400 di(meth)acrylate, polyethylene glycol 600 di(meth)acrylate, dipropylene glycol di(meth)acrylate, tripropylene glycol di(meth)acrylate, tetrapropylene glycol di(meth)acrylate, polypropylene glycol 400 di(meth)acrylate, polypropylene glycol 700 di(meth)acrylate, neopentyl glycol di(meth)acrylate, neopentyl glycol propylene oxide (PO)-modified di(meth)acrylate, ethylene oxide (EO)-modified bisphenol A di(meth)acrylate, PO-modified bisphenol A di(meth)acrylate, and neopentyl glycol hydroxypivalate di(meth)acrylate.

Examples of usable trifunctional or higher (meth)acrylate compounds include trimethylolpropane tri(meth)acrylate, trimethylolpropane EO-modified tri(meth)acrylate, trimethylolpropane PO-modified tri(meth)acrylate, glycerin propoxy tri(meth)acrylate, pentaerythritol tri(meth)acrylate, tris(acryloxyethyl)isocyanurate, and EO-modified pentaerythritol tetraacrylate.

Examples of usable vinyl compounds include vinyl acetate, vinyl benzoate, vinyl pivalate, vinyl butyrate, vinyl methacrylate, and N-vinylpyrrolidone.

As cationic polymerizable compounds, both photopolymerizable and thermally polymerizable types can be used. These can be used alone or in combination of two or more. Representative examples of cationic polymerizable compounds include epoxy compounds, oxetane compounds, and vinyl ether compounds.

The amount used of polymerizable compounds including the foregoing radical polymerizable compounds and cationic polymerizable compounds is desirably 1 to 99 parts by mass, more desirably 3 to 90 parts by mass, still more desirably 5 to 80 parts by mass, relative to the total mass of the photoresponsive composition.

The media 70 and 77 desirably contain organic groups. As the organic groups, at least one of linear, branched, or cyclic alkyl groups, linear, branched, or cyclic heteroalkyl groups, aryl groups, heteroaryl groups, aralkyl groups, and heteroaralkyl groups can be employed. The substituents contained in the media 70 and 77 may be partially substituted ones.

### (Polymerization Initiator)

In polymerization reactions, a polymerization initiator and a polymerizable compound are generally used in combination. As the polymerization initiator, known polymerization initiators which are compounds that generate active species to initiate polymerization reactions upon irradiation with active energy rays or heat can be used. Examples of main active species that initiate polymerization reactions include radical polymerization initiators that generate radicals and cationic polymerization initiators that generate acids, which may be used in combination. Examples of photoradical polymerization initiators that generate radicals upon irradiation with active energy rays include: acetophenones such as diethoxyacetophenone, 2-hydroxy-2-methyl-1-phenylpropan-1-one, benzyl methyl ketal, 4-(2-hydroxyethoxy)phenyl-(2-hydroxy-2-propyl) ketone, 1-hydroxycyclohexyl phenyl ketone, 2-methyl-1-[4-(methylthio)phenyl]-2-morpholinopropan-1-one, 2-benzyl-2-dimethylamino-1-(4-morpholinophenyl) butane, oligo [2-hydroxy-2-methyl-1-[4-(1-methylvinyl)phenyl]propanone], and 2-hydroxy-1-[4-[4-(2-hydroxy-2-methylpropionyl)benzyl]phenyl]-2-methylpropan-1-one; benzoins such as benzoin, benzoin methyl ether, benzoin ethyl ether, benzoin isopropyl ether, and benzoin isobutyl ether; phosphines such as 2,4,6-trimethylbenzoyl-diphenyl-phosphine oxide and bis(2,4,6-trimethylbenzoyl)-phenylphosphine oxide; and others including phenylglyoxylic methyl ester.

Of the photoradical polymerization initiators, acetophenones represented by aminoketones, phosphines, and oxime ester compounds are desirable. These can be used alone or in combination of two or more, depending on the properties desired for the cured article. When radical polymerization initiators are used, the amount used is desirably 0.01 to 100 parts by mass, more desirably 0.1 to 50 parts by mass, relative to 100 parts by mass of the total solid content in the composition.

### (Third Protective Layer)

The third protective layer 80 is disposed between the medium 70 or 77 and the first protective layer 20 and protects the first particles 30. The third protective layer 80 can be said to be disposed between the medium 70 or 77 and the first protective layer 20 and protects the first protective layer 20. The third protective layer 80 is configured to contain a polymer compound having third organic groups in its side chains. In addition, the third protective layer 80 desirably has absorbance (optical density) lower than that of the first nanoparticles in each of a first wavelength band including at least one of ultraviolet and blue and a second wavelength band related to the emission wavelength of the first nanoparticles. The third protective layer 80 covering the first particles 10 and the first protective layer 20 desirably has a particulate form with a diameter of 10 nm to 10 μm. The third protective layer 80 desirably has a crosslinked structure. The third protective layer 80 is provided so that the first protective layer 20 contacts the third protective layer 80 while the second protective layer 50 does not contact the third protective layer 80. The third protective layer 80 is also configured to encapsulate the first nanoparticles 10 and not encapsulate the second nanoparticles 40. Such provision of the third protective layer 80 further restricts the exchange of halogens derived from the first nanoparticles 10 and the second nanoparticles 40 via the media 70 and 77.

### (Third Organic Groups)

As the third organic groups, at least one of linear, branched, or cyclic alkyl groups, linear, branched, or cyclic heteroalkyl groups, aryl groups, heteroaryl groups, aralkyl groups, and heteroaralkyl groups can be employed. The third organic groups may contain partially substituted substituents.

### (Method for Forming Third Protective Layer)

The technique for forming the third protective layer 80 is not limited in particular. Examples include a technique of forming a bulk body of the third protective layer 80 covering the first particles 10 and the first protective layers 20 into fine particles in a top-down manner, and a technique of forming fine particles in a bottom-up manner. The techniques may be selected as appropriate depending on the application.

In the case of forming fine particles in a top-down manner, the bulk body of the third protective layer 80 containing the first particles 10 and the first protective layers 20 is initially formed. Examples of the method for forming the bulk body include a method of polymerizing a mixture containing a polymerizable compound, the first particles 10 and the first protective layers 20, and a method of mixing the first particles 10 and the first protective layers 20 with a polymer compound. Examples of the technique for forming the bulk body into fine particles include dry grinding, wet grinding, freeze grinding, and spray freeze drying. Examples of the technique for forming fine particles in a bottom-up manner include emulsion polymerization, suspension polymerization, dispersion polymerization, radical polymerization, sol-gel, reprecipitation, and microwave heating.

For dispersion polymerization, for example, fine particles can be obtained by polymerizing styrene or methacrylic acid ester in an organic solvent using polydimethylsiloxane terminated with methacryloxypropyl groups as a stabilizer.

The content of the third protective layer 80 relative to the first nanoparticles is desirably 1 part by mass to 1000 parts by mass, with the content of the first nanoparticles as 1 part by mass.

When observed under a transmission electron microscope (TEM), the first nanoparticles desirably have an average surface-to-surface distance of 1 nm to 100 nm.

### (Other Additives)

In the present embodiment, the photoresponsive composition may be mixed and used with oxygen scavengers, antioxidants, scattering agents such as titanium oxide, surfactants, antifungal agents, light stabilizers, additives that impart various other properties, diluting solvents, and the like as needed.

### Second Embodiment

A photoresponsive composition according to a second embodiment will be described with reference to FIG. 3. A photoresponsive composition 200 according to the second embodiment differs from the photoresponsive composition 100 according to the first embodiment in that the medium 77 contains a polymer 160 with increased viscosity, obtained by crosslinking the polymerizable compound 150.

### Third Embodiment

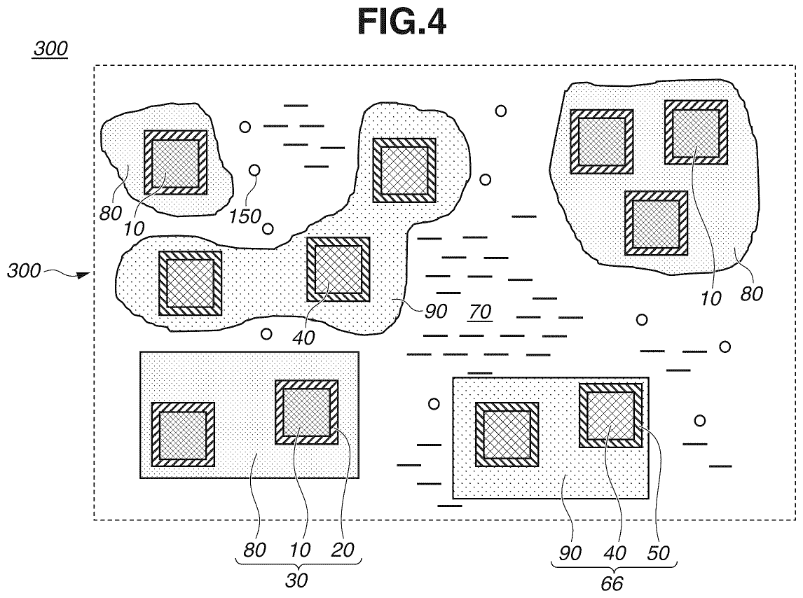

A photoresponsive composition according to a third embodiment will be described with reference to FIG. 4. A photoresponsive composition 300 according to the third embodiment differs from the photoresponsive composition 100 according to the first embodiment and the photoresponsive composition 200 according to the second embodiment in that second particles 66 include a fourth protective layer 90.

### (Fourth Protective Layer)

The fourth protective layer 90 is disposed between the medium 70 or 77 and the second protective layer 50 and protects the second particles. The fourth protective layer 90 can be said to be disposed between the medium 70 or 77 and the second protective layer 50 and protects the second protective layer 50. The fourth protective layer 90 desirably contains a polymer compound having fourth organic groups in its side chains. Moreover, the fourth protective layer 90 desirably has absorbance (optical density) lower than that of the second nanoparticles in each of the first wavelength band including at least one of ultraviolet and blue and a third wavelength band related to the emission wavelength of the second nanoparticles. The fourth protective layer 90 covering the second nanoparticles 40 and the second protective layers 50 desirably has a particulate form with a diameter of 10 nm to 10 μm. The fourth protective layer 90 desirably has a crosslinked structure. Like the third protective layer, the fourth protective layer 90 is provided so that the second protective layer 50 contacts the fourth protective layer 90 while the first protective layer 20 does not contact the fourth protective layer 90. The fourth protective layer 90 is configured to encapsulate the second nanoparticles 40 and not encapsulate the first nanoparticles 10. Such provision of the fourth protective layer 90 further restricts the exchange of halogens derived from the first nanoparticles 10 and the second nanoparticles 40 via the media 70 and 77.

### (Fourth Organic Groups)

As the fourth organic groups, at least one of linear, branched, or cyclic alkyl groups, linear, branched, or cyclic heteroalkyl groups, aryl groups, heteroaryl groups, aralkyl groups, and heteroaralkyl groups can be employed. The fourth organic groups may contain partially substituted substituents.

### (Method for Forming Fourth Protective Layer)

The technique for forming the fourth protective layer 90 is not limited in particular. Examples include a technique of forming a bulk body of the fourth protective layer 90 containing the second nanoparticles 40 and the second protective layers 50 into fine particles in a top-down manner, and a technique of forming fine particles in a bottom-up manner. The techniques may be selected as appropriate depending on the application.

In the case of forming fine particles in a top-down manner, the bulk body of the fourth protective layer 90 containing the second nanoparticles 40 and the second protective layers 50 is initially formed. Examples of the method for forming the bulk body include a method of polymerizing a mixture containing a polymerizable compound, the second nanoparticles 40 and the second protective layers 50, and a method of mixing the second nanoparticles 40 and the second protective layers 50 with a polymer compound. Examples of the technique for forming the bulk body into fine particles include dry grinding, wet grinding, freeze grinding, and spray freeze drying. Examples of the technique for forming fine particles in a bottom-up manner include emulsion polymerization, suspension polymerization, dispersion polymerization, radical polymerization, sol-gel, reprecipitation, and microwave heating.

For dispersion polymerization, for example, fine particles can be obtained by polymerizing styrene or methacrylic acid ester in an organic solvent using polydimethylsiloxane terminated with methacryloxypropyl groups as a stabilizer.

The content of the fourth protective layer 90 relative to the second nanoparticles is desirably 1 part by mass to 1000 parts by mass, with the content of the second nanoparticles as 1 part by mass.

When observed under a TEM, the second nanoparticles desirably have an average surface-to-surface distance of 1 nm to 100 nm.

### Fourth Embodiment

The fluid photoresponsive compositions 100, 200, and 300 exhibit the effect of the present disclosure that halogen exchange is reduced for stabilized composition even in a form where the photoresponsive compositions 100, 200, and 300 are cured on a substrate. The photoresponsive composition 200 (100, 300) takes the form of a layer supported by another member, and may thus be referred to as a wavelength conversion layer. Examples of the support form include a laminated form and a dispersed form where the photoresponsive composition is dispersed in a matrix material. Examples of the wavelength conversion layer include ones obtained by applying the photoresponsive composition to a support member (substrate) and curing it to form a film, sheet, or patterned pixels.

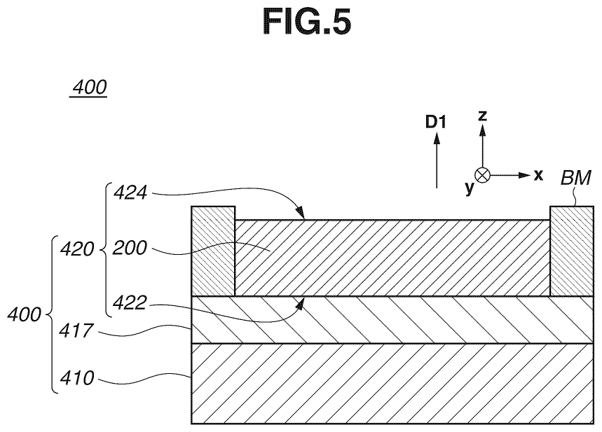

FIG. 5 illustrates a sectional structure of a display element 400 according to a fourth embodiment.

The display element 400 includes a light-emitting layer 410, a dielectric multilayer film 417, and a wavelength conversion layer 420 that are stacked in a stacking direction D1. The downstream side in the stacking direction D1 coincides with the side where a user who views images drawn on the display element is. The wavelength conversion layer 420 is partitioned from the wavelength conversion layer corresponding to adjacent elements by a pixel-isolating black matrix BM.

As described above, the photoresponsive composition 200 is cured with the polymerizable compound 150 through polymerization treatment such as photopolymerization treatment. The photoresponsive composition 200 is cured into a solid photoresponsive composition 420 supported by the dielectric multilayer film 417. The photoresponsive composition 420 is configured to satisfy predetermined dimensions and thereby constitutes the wavelength conversion layer 420 of the display element 400. In other words, the wavelength conversion layer 420 is a layer solidified by curing the entire photoresponsive composition 200 with the polymerizable compound 150.

The light-emitting layer 410 corresponds to a light source that emits light L1 of first wavelength λ1. The wavelength conversion layer 420 has an optical coupling surface 422 that is optically coupled with the light-emitting layer 410 on the light-emitting layer 410-side, and an extraction surface 424 from which secondary light L2 converted by the wavelength conversion layer 420 is extracted on the side opposite the light-emitting layer 410.

The wavelength conversion layer 420 according to the present embodiment receives the primary light L1 of wavelength Δ1 propagating through the dielectric multilayer film 417. The dielectric multilayer film 417 provides the display element 400 with spectral transmission characteristics for the primary light from the light-emitting layer 410 and spectral reflection characteristics for the secondary light L2 of wavelength λ2 to be emitted from the wavelength conversion layer 420. The wavelength λ2 of the secondary light L2 is longer than the wavelength Δ1 of the primary light L1.

The dielectric multilayer film 417 can be replaced with other optical members having optical transparency to the first wavelength Δ1 emitted from the light-emitting layer 410. Moreover, not-illustrated other optical members may be disposed in front of the extraction surface 424 (on the side opposite the light-emitting layer 410).

### (Method for Forming Wavelength Conversion Layer)

The method for forming the wavelength conversion layer is not limited in particular. Examples include a method of applying the photoresponsive composition to the substrate, followed by pre-drying as needed, and further performing heat treatment or active energy ray irradiation as needed to cure the film. The cured wavelength conversion layer desirably has a thickness of 0.1 to 200 μm, more desirably 1 to 100 μm.

As the active energy rays in the active energy ray irradiation, electromagnetic waves that reduce fluidity and promote curing through polymerization, crosslinking, drying, and the like are selected as appropriate from heat rays, ultraviolet rays, visible light rays, near-infrared rays, electron beams, and the like. The light source for applying the active energy rays is desirably one having a main emission wavelength in the wavelength range of 100 to 450 nm. Examples of such a light source include ultra-high pressure mercury lamps, high pressure mercury lamps, medium pressure mercury lamps, mercury xenon lamps, metal halide lamps, high-power metal halide lamps, xenon lamps, pulsed xenon lamps, deuterium lamps, fluorescent lamps, neodymium-doped yttrium aluminum garnet (Nd:YAG) third harmonic lasers, He-CD lasers, nitrogen lasers, Xe-Cl excimer lasers, Xe-F excimer lasers, semiconductor-pumped solid-state lasers, and LED lamp sources with emission wavelengths of 365 nm, 375 nm, 385 nm, 395 nm, and 405 nm.

### ((Measurement Methods))

Various physical properties can be measured as follows.

### ((Molecular Weight Distribution Measurement))

The molecular weight distribution of the polymer compounds in the first and second protective layers can be calculated in terms of monodisperse polymethyl methacrylate by gel permeation chromatography (GPC). For example, the GPC molecular weight measurement can be performed in the following manner.

Prepare sample solutions by adding each sample to the eluent to be described below so that the sample concentration becomes 1 mass %, allowing it to stand at room temperature for 24 hours to dissolve, and filtering the resulting solution through a solvent-resistant membrane filter with a pore size of 0.45 μm. Perform measurements under the following conditions:

Instrument: Agilent 1260 infinity system (manufactured by Agilent Technologies, Inc.) Column: PFG analytical linear M columns (manufactured by Polymer Standards Service [PSS])
Eluent: 2,2,2-trifluoroethanol
Flow rate: 0.2 ml/min
Oven temperature: 40° C.
Sample injection volume: 20 μL

To calculate the molecular weight distributions of the samples, use a molecular weight calibration curve prepared using standard polymethyl methacrylate resin (Easi Vial PM Polymer Standard Kit, manufactured by Agilent Technologies, Inc.).

### ((Composition Analysis))

The compositional analysis of the first and second protective layers can be performed using nuclear magnetic resonance (NMR). For example, conduct 1H-NMR and 13C-NMR spectral measurements using ECA-600 (600 MHZ) manufactured by JEOL Ltd. In doing so, perform the measurements at 25° C. in a deuterated solvent containing tetramethylsilane as an internal standard. For chemical shift values, read ppm shift values (8 values) with the internal standard tetramethylsilane as 0.

((Crystalline structure Analysis))

The crystalline structure analysis and compositional analysis of the first nanoparticles and second nanoparticles can be performed using X-ray diffraction (XRD). For example, the crystalline structure and composition can be analyzed by measuring X-ray diffraction patterns using a RINT 2100 (manufactured by Rigaku). Depending on the morphology and size of the analytical specimens, electron diffraction (ED) accompanying cross-sectional TEM may be employed.

### ((Compositional Analysis of First Nanoparticles and Second Nanoparticles))

The compositional analysis of both the first nanoparticles and second nanoparticles can also be performed using X-ray photoelectron spectroscopy (XPS) and inductively coupled plasma (ICP) emission spectroscopy. The molar ratio of A-site and B-site can be determined from the XPS signal intensity, and the concentration of X-site can be measured from the emission intensity of ICP emission spectroscopy [for example, CIROS CCD manufactured by SPECTRO Analytical Instruments GmbH]).

### ((Amounts of First Nanoparticles and Second Nanoparticles))

The amount of the first nanoparticles 10 or the second nanoparticles 40 contained in the photoresponsive composition 100 can be measured using ICP emission spectroscopy. For example, measure the amount of Pb from the emission intensity of ICP emission spectroscopy, and compare the measurement with the compositional information about the first nanoparticles 10 and second nanoparticles 40 obtained by the foregoing method. The amounts of the first nanoparticles 10 and second nanoparticles 40 can thereby be calculated.

### ((Amounts of First and Second Protective Layers Relative to Nanoparticles))

The amounts of the first and second protective layers relative to the respective first and second nanoparticles can be determined by thermogravimetric differential thermal analysis (TG-DTA) measurement. The amounts can also be determined from the NMR integrated intensity of the first particles 30 or the second particles 40.

### ((Medium Composition))

When the medium 70 is in a liquid or fluid form, compositional analysis can be performed using NMR and mass spectrometry. When the medium 77 is solid (cured article), compositional analysis can be performed using pyrolysis gas chromatography.

### ((Checking for Presence of Third Protective Layer in Photoresponsive Compositions))

When the photoresponsive compositions 100 and 300 (medium 70) are liquid, the presence can be checked by separating the medium 70 and the first particles 30 containing the third protective layer 80 from the photoresponsive compositions 100 and 300 by centrifugation. When the photoresponsive composition 200 (medium 77) is solid, the presence can be checked by TEM observation. If there is no third protective layer 80, the first particles 30 uniformly distributed throughout the medium are observed. If the third protective layer 80 is present, an uneven distribution is observed.

### ((Amount of First Nanoparticles 10 in First Particles 30))

The amount of the first nanoparticles 10 contained in the first particles 30 can be measured using ICP emission spectroscopy. The mixture containing the third protective layer 80, the first nanoparticles 10, and the first protective layer 20 can be acid-digested for the ICP emission spectroscopy. The amount of the second nanoparticles 40 contained in the second particles 60 can be determined in a similar manner.

### ((Method for Calculating Particle Diameter of First Particles 30))

The particle diameter of the first particles 30 including the third protective layer 80 can be calculated through TEM observation.

### ((Average Surface-to-Surface Distance of First Nanoparticles 10 Contained in First Particles 30))

The average surface-to-surface distance of the first nanoparticles 10 contained in the first particles 30 can be calculated through TEM observation.

### EXAMPLES

The present disclosure will hereinafter be described in further detail with reference to examples. However, the present disclosure is not limited thereto.

[Manufacture of Polymer Compound a]

A reaction vessel equipped with a cooling tube, a stirrer, a thermometer, and a nitrogen inlet tube was prepared. Into this reaction vessel, 26.5 parts of 3-[[2-(methacryloyloxy)ethyl]dimethylammonio]propane-1-sulfonic acid, 42.3 parts of hexyl methacrylate, 3.9 parts of azobisisobutyronitrile, and 900 parts of 2,2,2-trifluoroethanol were charged. Further, nitrogen bubbling was performed in this reaction vessel for 30 minutes.

The obtained reaction mixture was heated at 70° C. for 8 hours under a nitrogen atmosphere to complete the polymerization reaction. After the reaction liquid was cooled to room temperature, 300 parts of water was added to precipitate the product. After centrifugation, the supernatant was removed. The solvent was removed under reduced pressure, and then polymer compound a was obtained by drying under reduced pressure at 50° C. and 0.1 kPa or less. NMR measurement found that the ratio of units containing sulfobetaine groups in the polymer was 18 mol %.

[Manufacture of Polymer Compound b]

Polymer compound b was manufactured in a manner similar to the manufacture of polymer compound a, except that 3-[[2-(methacryloyloxy)ethyl]dimethylammonio]propane-1-sulfonic acid was changed from 26.5 parts to 10.2 parts, and hexyl methacrylate was changed from 42.3 parts to 45.4 parts. NMR measurement found that the ratio of units containing sulfobetaine groups in the polymer was 12 mol %.

[Manufacture of Polymer Compound c]

Polymer compound c was manufactured in a manner similar to the manufacture of polymer compound a, except that 26.5 parts of 3-[[2-(methacryloyloxy)ethyl]dimethylammonio]propane-1-sulfonic acid was replaced with 4.7 parts of methacrylic acid, and hexyl methacrylate was changed from 45.4 parts to 42.3 parts. NMR measurement found that the ratio of units containing carboxy groups in the polymer was 18 mol %.

### [Preparation of Polymer Compound Solutions]

### (Toluene Solution of Polymer Compound a)

Into a reaction vessel equipped with a stirrer, a thermometer, and a reflux condenser, 1 part of polymer compound a and 99 parts of toluene were charged. The temperature was raised to 110° C., and heating was continued for 5 minutes. After complete dissolution of polymer compound a was confirmed, the solution was cooled to room temperature to obtain a toluene solution of polymer compound a.

### (Toluene Solution of Polymer Compound b)

A toluene solution of polymer compound b was prepared in a manner similar to that of the toluene solution of polymer compound a, except that polymer compound b was used instead of polymer compound a.

### (Toluene Solution of Polymer Compound c)

A toluene solution of polymer compound c was prepared in a manner similar to that of the toluene solution of polymer compound a, except that polymer compound c was used instead of polymer compound a.

[Manufacture of First Nanoparticle Dispersion a]

In a flask, 10 parts of cesium carbonate, 27 parts of oleic acid, and 385 parts of 1-octadecene were placed. The liquid was heated to 120° C., and degassed for 30 minutes with a vacuum pump. The liquid was further heated to 150° C. and maintained for 30 minutes under a dry nitrogen stream to obtain a cation raw material liquid.

Separately, 10 parts of lead (II) bromide and 494 parts of 1-octadecene were placed in a flask. The liquid was heated to 120° C., and degassed for 1 hour with a vacuum pump. Eighty-nine parts of oleic acid and 31 parts of oleylamine were added, and the mixture was further degassed for 30 minutes with a vacuum pump. The atmosphere was then switched to nitrogen flow and the liquid temperature was raised to 185° C.

Forty parts of cationic raw material solution was added, and after 5 seconds, the mixture was ice-cooled. With 2000 parts of ethyl acetate added, centrifugation was performed, and the supernatant was removed. The obtained residue was dispersed in toluene to adjust the solid content concentration to 1 wt %, whereby dispersion a of first nanoparticles having a perovskite crystalline structure of CsPbBr₃ was obtained.

[Manufacture of Second Nanoparticle Dispersion b]

Dispersion b of second nanoparticles having a perovskite crystalline structure of CsPb(Br/I)₃ was obtained in a manner similar to that of the first nanoparticle dispersion a, except that 3.2 parts of lead (II) bromide and 9.3 parts of lead (II) iodide were used instead of 10 parts of lead (II) bromide.

### First Example

### [Preparation of Hexane Dispersion of First Particles 30-1]

Ten parts of the foregoing first nanoparticle dispersion a were placed in a container, and the solvent was removed under reduced pressure. To this, 10 parts of toluene solution of polymer compound a were added and stirred for 1 hour, and the solvent was removed under reduced pressure. Ten parts of hexane were added to obtain a hexane dispersion of first particles 30-1.

### [Preparation of Hexane Dispersion of Second Particles 60-1]

A hexane dispersion of second particles 60-1 was obtained in a manner similar to that of the first particles 30-1, except that the second nanoparticle dispersion b was used instead of the first nanoparticle dispersion a.

### [Preparation of First Particles 30-1 Containing Third Protective Layer 80 and First Nanoparticles]

Thirty parts of hexane dispersion of the first particles 30-1, 200 parts of hexane, 5 parts of polydimethylsiloxane terminated with methacryloxypropyl groups (manufactured by Gelest, trade name DMS-R22), 30 parts of methyl methacrylate, 3 parts of trimethylolpropane trimethacrylate, and 2 parts of 2,2′-azobis(4-methoxy-2,4-dimethylvaleronitrile) were mixed and allowed to reacted at 40° C. for 2 hours.

After the reaction was stopped by ice cooling, 200 parts of hexane were added, followed by centrifugation and removal of the supernatant. Four hundred parts of hexane were added for redispersion, followed by centrifugation and removal of the supernatant. The solvent was removed under reduced pressure to obtain first particles 30-1 containing the third protective layer 80, first nanoparticles 10, and first protective layer 20.

### [Preparation of Second Particles 60-1 Containing Fourth Protective Layer 90, Second Nanoparticles 40, and Second Protective Layer 50]

Second particles 60-1 containing the fourth protective layer 90, second nanoparticles 40, and second protective layer 50 were obtained in a manner similar to that of the first particles 30-1 containing the third protective layer 80, first nanoparticles 10, and first protective layer 20, except that the hexane dispersion of the second particles 60-1 were used instead of the hexane dispersion of the first particle 30-1.

### [Manufacture of Photoresponsive Composition 60-1]

Ten parts of first particles 30-1 containing the third protective layer 80, first nanoparticles 10, and first protective layer 20, 10 parts of particles 1 containing the fourth protective layer 90, second particles 40, and second protective layer 50, 75 parts of butyl acrylate, and 5 parts of 2,4,6-trimethylbenzoyl-diphenyl-phosphine oxide (manufactured by IGM Resins, trade name: Omnirad TPO) were mixed therein to obtain photoresponsive composition 1.

### Second Example

### [Preparation of Hexane Dispersion of First Particles 30-2]

A hexane dispersion of first particles 30-2 was obtained in a manner similar to that of the hexane dispersion of first particles 30-1, except that polymer compound a was changed to polymer compound c.

### [Preparation of Hexane Dispersion of Second Particles 60-2]

A hexane dispersion of second particles 60-2 was obtained in a manner similar to that of the hexane dispersion of second particles 60-1, except that polymer compound b was changed to polymer compound c.

### [Preparation of First Particles 30-2 Containing Third Protective Layer 80, First Nanoparticles 10, and First Protective Layer 20]

First particles 30-2 containing the third protective layer 80, first nanoparticles 10, and first protective layer 20 were obtained in a manner similar to that of the first particles 30-1 containing the third protective layer 80, first nanoparticles 10, and first protective layer 20, except that the hexane dispersion of the first particles 30-2 were used instead of the hexane dispersion of the first particles 30-1.

### [Preparation of Second Particles 60-2 Containing Fourth Protective Layer 90 and Second Nanoparticles 40]

Second particles 60-2 containing the fourth protective layer 90, second nanoparticles 40, and second protective layer 50 were obtained in a manner similar to that of the first particles 30-1 containing the fourth protective layer 90, second nanoparticles 40, and second protective layer 50, except that the hexane dispersion of the first particles 30-2 was used instead of the hexane dispersion of the first particles 30-1.

### [Manufacture of Photoresponsive Composition 2]

Photoresponsive composition 2 was obtained in a manner similar to that of photoresponsive composition 1, except that first particles 30-2 were used instead of first particles 30-1 and second particles 60-2 were used instead of second particles 60-1.

### Third Example

### [Manufacture of Photoresponsive Composition 3]

Ten parts of hexane dispersion of second particles 60-1 were placed in a container, and the solvent was removed under reduced pressure. To this, 10 parts of first particles 30-1 containing the third protective layer 80 and first nanoparticles 10, 75 parts of butyl acrylate, and 5 parts of 2,4,6-trimethylbenzoyl-diphenyl-phosphine oxide (manufactured by IGM Resins, trade name Omnirad TPO) were mixed to obtain photoresponsive composition 3.

### Comparative Example 1

Ten parts of hexane dispersion of first particles 30-1 and 10 parts of hexane dispersion of second particles 60-1 were placed in a container, and the solvent was removed under reduced pressure. To this, 75 parts of butyl acrylate and 5 parts of 2,4,6-trimethylbenzoyl-diphenyl-phosphine oxide (manufactured by IGM Resins, trade name Omnirad TPO) were mixed to obtain photoresponsive composition 4.

Table 1 illustrates the formulation of each photoresponsive composition.

TABLE 1

| | | | First | Third | | Second | Fourth | |
|---|---|---|---|---|---|---|---|---|
| | Photoresponsive | First | protective | protective | Second | protective | protective | |
| No. | composition | nanoparticles | layer | layer | nanoparticles | layer | layer | Medium |
| First | photoresponsive | dispersion a | polymer | polymethyl | dispersion b | polymer | polymethyl | butyl acrylate |
| Example | composition 1 | | compound a | methacrylate | | compound b | methacrylate | |
| | | | | (crosslinked) | | | (crosslinked) | |
| Second | photoresponsive | dispersion a | polymer | polymethyl | dispersion b | polymer | polymethyl | butyl acrylate |
| Example | composition 2 | | compound c | methacrylate | | compound c | methacrylate | |
| | | | | (crosslinked) | | | (crosslinked) | |
| Third | photoresponsive | dispersion a | polymer | polymethyl | dispersion b | polymer | none | butyl acrylate |
| Example | composition 3 | | compound a | methacrylate | | compound b | | |
| | | | | (crosslinked) | | | | |
| First | photoresponsive | dispersion a | polymer | none | dispersion b | polymer | none | butyl acrylate |
| Comparative | composition 4 | | compound a | | | compound b | | |
| Example | | | | | | | | |

### <Evaluation of Photoresponsive Compositions>

The obtained photoresponsive compositions were subjected to the following evaluations. Table 2 illustrates the results.

### [Color Mixing Evaluation]

Each photoresponsive composition was measured for the emission peak wavelength immediately after production and after 5 minutes. The measurement conditions and evaluation criteria are as follows.

### <Measurement Conditions>

Measurement apparatus: absolute photoluminescence (PL) quantum yield measurement system C9920-03 (manufactured by Hamamatsu Photonics K.K.)
Excitation light wavelength: 460 nm
Excitation light integration range: excitation light wavelength+10 nm
Emission integration range: (excitation light wavelength+20) nm to 770 nm

### <Evaluation Criteria>

The absolute value of the difference between the wavelengths at which the light emission reached its maximum value in the range of 500 nm to 600 nm immediately after production and after 5 minutes was calculated, and evaluated according to the following criteria:
A: the absolute value of the wavelength difference is 0 nm or more and less than 20 nm
B: the absolute value of the wavelength difference is 20 nm or more and less than 50 nm
C: the absolute value of the wavelength difference is 50 nm or more

Table 2 illustrates the evaluations.

TABLE 2

| No. | Evaluation |
|---|---|
| First example | A |
| Second example | B |
| Third example | B |
| First comparative example | C |

According to Table 2, photoresponsive compositions 1 to 3 according to the first to third examples exhibit reduced color mixing compared to photoresponsive composition 4 according to the first comparative example. The reason is presumed to be that the two types of nanoparticles having perovskite-type structures are protected by a plurality of protective layers with specific structures.

Photoresponsive compositions according to the embodiments described in this description apply to at least one of the following configurations 1 to 18.

### Configuration 1

A photoresponsive composition including
a medium;
a first particle including a first nanoparticle, a first protective layer, and a third protective layer and supported by the medium, the first nanoparticle having a photoresponsive perovskite-type crystalline structure, the first protective layer including a first organic group and a first linking portion coordinating to the first nanoparticle, the first protective layer protecting the first nanoparticle, the third protective layer being disposed between the medium and the first protective layer and protecting the first particle; and
a second particle including a second nanoparticle and a second protective layer and supported by the medium, the second nanoparticle having a perovskite-type crystalline structure with a composition different from that of the first nanoparticle, the second protective layer including a second organic group and a linking portion coordinating to the second nanoparticle, the second protective layer protecting the second nanoparticle.

### Configuration 2

The photoresponsive composition according to Configuration 1, wherein the third protective layer contains a polymer having a third organic group in a side chain.

### Configuration 3

The photoresponsive composition according to Configuration 1 or 2, wherein the first protective layer is in contact with the third protective layer, and the second protective layer is not in contact with the third protective layer.

### Configuration 4

The photoresponsive composition according to Configuration 1 or 2, wherein the first protective layer is protected by the third protective layer.

### Configuration 5

The photoresponsive composition according to any one of Configurations 1 to 4, wherein the third protective layer encapsulates the first particle and not encapsulate the second particle.

### Configuration 6

The photoresponsive composition according to any one of Configurations 1 to 5, wherein the third protective layer has absorbance lower than that of the first nanoparticle in both a first wavelength band including at least one of ultraviolet and blue and a second wavelength band related to an emission wavelength of the first nanoparticle.

### Configuration 7

The photoresponsive composition according to any one of Configurations 1 to 6, wherein the medium contains a polymerizable compound.

### Configuration 8

The photoresponsive composition according to Configuration 7, wherein the medium contains a solvent.

### Configuration 9

The photoresponsive composition according to any one of Configurations 1 to 8, wherein the medium contains a polymer matrix in which both the first particle and the second particle are dispersed.

### Configuration 10

The photoresponsive composition according to Configuration 9, wherein the medium is a sheet-shaped solid.

### Configuration 11

The photoresponsive composition according to Configuration 1, wherein the second particle includes a fourth protective layer disposed between the medium and the second protective layer and protecting the second particle.

### Configuration 12

The photoresponsive composition according to Configuration 11, wherein the fourth protective layer contains a polymer having a fourth organic group in a side chain.

### Configuration 13

The photoresponsive composition according to Configuration 11 or 12, wherein the second protective layer is in contact with the fourth protective layer, and the first protective layer is not in contact with the fourth protective layer.

### Configuration 14

The photoresponsive composition according to any one of Configurations 11 to 13, wherein the second protective layer is protected by the fourth protective layer.

### Configuration 15

The photoresponsive composition according to any one of Configurations 11 to 14, wherein the fourth protective layer encapsulates the second particle and does not encapsulate the first particle.

### Configuration 16

The photoresponsive composition according to any one of Configurations 11 to 15, wherein the fourth protective layer has absorbance lower than that of the first nanoparticle in both a first wavelength band including at least one of ultraviolet and blue and a third wavelength band related to an emission wavelength of the second nanoparticle.

### Configuration 17

The photoresponsive composition according to any one of Configurations 1 to 16, wherein the first particle exhibits an emission characteristic of emitting a greater amount of either green light or red light, and the second particle exhibits an emission characteristic of emitting a greater amount of the other of green light and red light.

### Configuration 18

The photoresponsive composition according to any one of Configurations 1 to 17, wherein the first particle contains a greater amount of either bromine or iodine, and the second particle contains a greater amount of the other of bromine and iodine.

The present disclosure is not limited to the foregoing embodiments, and various changes and modifications can be made without departing from the spirit and scope of the present disclosure. The following claims are therefore appended to make public the scope of the present disclosure.

According to the present disclosure, a photoresponsive composition that includes perovskite-type quantum dots supported by a common medium and having mutually different compositions and in which color mixing is reduced can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A photoresponsive composition comprising:
a medium;
a first particle including a first nanoparticle, a first protective layer, and a third protective layer and supported by the medium, the first nanoparticle having a photoresponsive perovskite-type crystalline structure, the first protective layer including a first organic group and a first linking portion coordinating to the first nanoparticle, the first protective layer protecting the first nanoparticle, the third protective layer being disposed between the medium and the first protective layer and protecting the first particle; and
a second particle including a second nanoparticle and a second protective layer and supported by the medium, the second nanoparticle having a perovskite-type crystalline structure with a composition different from that of the first nanoparticle, the second protective layer including a second organic group and a linking portion coordinating to the second nanoparticle, the second protective layer protecting the second nanoparticle.

2. The photoresponsive composition according to claim 1, wherein the third protective layer contains a polymer having a third organic group in a side chain.

3. The photoresponsive composition according to claim 1, wherein the first protective layer is in contact with the third protective layer, and the second protective layer is not in contact with the third protective layer.

4. The photoresponsive composition according to claim 1, wherein the first protective layer is protected by the third protective layer.

5. The photoresponsive composition according to claim 1, wherein the third protective layer encapsulates the first particle and not encapsulate the second particle.

6. The photoresponsive composition according to claim 1, wherein the third protective layer has absorbance lower than that of the first nanoparticle in both a first wavelength band including at least one of ultraviolet and blue and a second wavelength band related to an emission wavelength of the first nanoparticle.

7. The photoresponsive composition according to claim 1, wherein the medium contains a polymerizable compound.

8. The photoresponsive composition according to claim 7, wherein the medium contains a solvent.

9. The photoresponsive composition according to claim 1, wherein the medium contains a polymer matrix in which both the first particle and the second particle are dispersed.

10. The photoresponsive composition according to claim 9, wherein the medium is a sheet-shaped solid.

11. The photoresponsive composition according to claim 1, wherein the second particle includes a fourth protective layer disposed between the medium and the second protective layer and protecting the second particle.

12. The photoresponsive composition according to claim 11, wherein the fourth protective layer contains a polymer having a fourth organic group in a side chain.

13. The photoresponsive composition according to claim 11, wherein the second protective layer is in contact with the fourth protective layer, and the first protective layer is not in contact with the fourth protective layer.

14. The photoresponsive composition according to claim 11, wherein the second protective layer is protected by the fourth protective layer.

15. The photoresponsive composition according to claim 1, wherein the fourth protective layer encapsulates the second particle and does not encapsulate the first particle.

16. The photoresponsive composition according to claim 11, wherein the fourth protective layer has absorbance lower than that of the first nanoparticle in both a first wavelength band including at least one of ultraviolet and blue and a third wavelength band related to an emission wavelength of the second nanoparticle.

17. The photoresponsive composition according to claim 1, wherein the first particle exhibits an emission characteristic of emitting a greater amount of either green light or red light, and the second particle exhibits an emission characteristic of emitting a greater amount of the other of green light and red light.

18. The photoresponsive composition according to claim 1, wherein the first particle contains a greater amount of either bromine or iodine, and the second particle contains a greater amount of the other of bromine and iodine.
